(19) United States
(12) Patent Application Publication
(10) Pub. No.: US 2009/0158591 A1
(43) Pub. Date: Jun. 25, 2009

(54) CLADDING FOR FATIGUE CONTROL

(76) Inventors: Philip A. Huff, Spring, TX (US); Shafiq Khandoker, Houston, TX (US)

Correspondence Address: OSHA LIANG L.L.P., TWO HOUSTON CENTER, 909 FANNIN, SUITE 3500, HOUSTON, TX, 77010, US

(21) Appl. No.: 11/962,661

(22) Filed: Dec. 21, 2007

(51) Int. Cl. B23K 31/12; B23K 9/00

(52) U.S. Cl. 29/897.1; 219/137 R; 277/325

(57) ABSTRACT

A method of manufacturing an oilfield component includes analyzing a first model of the oilfield component, identifying at least one region in the oilfield component susceptible to fatigue failure at a selected loading condition, constructing the oilfield component from a base material, and selectively reinforcing with a clad material the at least one region susceptible to failure.

### BACKGROUND OF INVENTION

1. Field of the Invention

Embodiments disclosed herein relate generally to oilfield components and equipment used during oil and gas production. Specifically, embodiments disclosed herein relate to a method of manufacturing or reinforcing oilfield components subject to fatigue failure.

2. Background

A variety of designs exist for the drilling and production of hydrocarbons, including land-based and offshore drilling and production units. Offshore drilling and production unit designs may vary based upon water depth and the type of platform used, such as a floating platform, semi-submersible platforms, tension leg platforms, spar-type platforms, and others as are known in the art. Offshore units also vary in the type and location of control devices, including wet-tree systems, where the control devices are located atop a wellhead on the sea flow, and dry-tree systems, where the control devices are located on the platform.

Components used during the drilling and production of oil wells, regardless of the location and design, are subject to corrosion, wear, and fatigue. For example, with respect to offshore drilling and production, the components and equipment used are subject to a dynamic environment, where near-surface and sub-surface currents may impart bending and/or rotational stress. In a typical offshore platform, a riser extends between the platform, at the surface of the ocean, and the wellhead, at the sea floor. Because the wellhead is statically located at the sea floor and the riser and the platform or drilling rig are motive, bending and rotational stresses may fatigue various rig components, including buoyancy devices, stress-relief subs, pad-eye connections for ballast or tension lines, stress joints, blowout preventers (“BOPs”), well control assemblies, mud lift modules, ballast weights, and other components known in the art. Each of these components, including the connections at the platform, the riser joints, and the wellhead components, may experience cyclical stress and strain associated with the dynamics of the offshore environment.

In addition to the dynamic, abrasive, and corrosive stresses described above, oilfield components may also be subject to fatigue due to the high pressures and temperatures encountered during the drilling and production process. The process of drilling wells involves penetrating a variety of subsurface geologic structures. Occasionally, a wellbore will penetrate a layer having a formation pressure substantially higher than the pressure maintained in the wellbore. When this occurs, the well is said to have “taken a kick.” The pressure increase associated with the kick is generally produced by an influx of formation fluids and tends to propagate uphole from a point of entry in the wellbore. Thus, normal operating pressures and high pressure kicks subject the oilfield components to additional fatigue.

Typically, oilfield components subject to fatigue are manufactured from a single, low-alloy steel. Low-alloy steels are steels having 5% or fewer alloying elements that may be processed (through cold work or heat treatment) to achieve various mechanical properties (e.g., yield strength, ultimate tensile strength, ductility, hardness, etc.) desired in a particular application. While more exotic non-ferrous “superalloys” are beneficial in that they frequently offer enhanced strength, corrosion resistance, and fatigue resistance over low-alloy steels, they are significantly more expensive and may be difficult to machine. Thus, the exclusive use of a high-strength non-ferrous alloy in the manufacture of oilfield components would normally be disadvantageous with regard to material acquisition and labor costs.

Further, in many cases, oilfield components may need to meet industry standard design criteria for metallic oil and gas field components, such as those requirements established by NACE International (formerly the National Association of Corrosion Engineers) and the European Federation of Corrosion (EFC) for the performance of metals when exposed to various environmental compositions, pH, temperature, and H2S partial pressures. For example, NACE MR0175 limits the maximum hardness of the parts to Rockwell C 22 or Brinell 237 for most low-alloy steels in the quenched and tempered condition.

For most low-alloy steels, the maximum yield strength that they are able to reach under such NACE maximum hardness limitation is about 90,000 psi. Very few low-alloy steels are able to develop this yield strength and hardness combination in a section thickness having any significant useable size. For example, when a cross-section is more than four to six inches thick, many low-alloy steels may be unable to develop the desired mechanical properties on quench and temper throughout the entire section thickness at the time of heat treatment.

Since fatigue life may be affected by the amount of stress imposed on a material relative to its yield strength, many materials exhibit a shorter life in fatigue when the stress applied exceeds as low as 50% of its yield strength. Consequently, if the parts are used in fatigue loading conditions such as those defined in NACE MR0175, the allowable applied stress may be limited to 50 to 65 ksi or less.

If fatigue failure occurs at these stress levels, there is little that may be done other than to reduce the applied stress by reducing the load on the affected component. Because the mechanical strength of the alloy cannot be increased significantly without exceeding the maximum hardness value mandated by NACE MR0175, reducing the applied stress was the only cost effective solution formerly available. Furthermore, fatigue strength is dependent on ductility as well. Thus, because ductility and strength are inversely related material properties, raising the strength of a material to accommodate fatigue properties may be counterproductive.

Fatigue failure is a phenomena that results from high tensile stress at the surface or within close proximity to the surface of a material. Therefore, surface modification procedures, such as shot peening, case hardening by nitriding or carburizing, and flame hardening or induction hardening have been used to improve the fatigue resistance of a material by leaving a residual compressive stress at the surface. Components containing a residual compressive stress at their surface are less likely to fail in fatigue since cracking is more difficult to initiate and/or propagate when the component is residually loaded in compression.

While these surface modification procedures may aid in reducing or eliminating fatigue failures, shot peening and nitriding are superficial while carburizing and flame or induction hardening generally are not capable of modifying the material properties to depths below the surface of more than approximately 0.050 inches. Furthermore, these surface modification methods may be at odds with or violate the requirements of NACE MR0175 for use of the equipment in sour service or sea water environments. For example, the hardness induced on the surface or near subsurface may be in excess of the threshold value for sulfide or chloride stress corrosion cracking.

As mentioned above, the lifespan of an oilfield component may also be affected by corrosion, such as by exposure to H₂S. For many years, parts in the oil tool industry have been clad overlaid on the ring grooves, sealing areas, and wetted surfaces solely for the purpose of corrosion resistance. For example, U.S. Pat. No. 6,737,174 discloses a sucker rod having a surface coated by a copper alloy. Similarly, a corrosion resistant alloy (“CRA”) clad layer, such as nickel-based Alloy 625 may be applied in thicknesses nominally from 0.060 to 0.187 inches to protect a base metal from corrosive attack. Other CRAs may be used in these applications, but the industry has essentially standardized Alloy 625 for corrosion resistant cladding of oil tool equipment. In the state of the art thus far, there has been little, if any, attention paid to the strength of the cladding material except to assure that the clad layer material did not weaken the base metal.

Therefore, oilfield components and parts having an increased service life are desired, including parts subject to corrosive and/or fatigue loading conditions, including cyclic fatigue loading conditions. Accordingly, there exists a need for oilfield components that have improved performance under fatigue loading conditions.

### SUMMARY OF INVENTION

In one aspect, embodiments disclosed herein relate to a method of manufacturing an oilfield component. The method includes analyzing a first model of the oilfield component and identifying at least one region in the oilfield component susceptible to fatigue failure at a selected loading condition. Further, the method includes constructing the oilfield component from a base material and selectively reinforcing with a clad material the at least one region susceptible to failure.

In another aspect, embodiments disclosed herein relate to a method to reinforce an oilfield component. The method comprises analyzing the oilfield component, identifying at least one region susceptible to fatigue failure in the oilfield component, and selectively reinforcing with a high-strength material the at least one region susceptible to fatigue failure.

In another aspect, embodiments disclosed herein relate to a ram blowout preventer having a body, a vertical bore through the body, a horizontal bore through the body intersecting the vertical bore, two ram assemblies disposed in the horizontal bore on opposite sides of the body, and a flange neck. The ram assemblies are adapted for controlled lateral movement to and from the vertical bore, and at least a portion of the flange neck is selectively reinforced to improve fatigue resistance.

Other aspects and advantages will be apparent from the following description and the appended claims.

### BRIEF DESCRIPTION OF DRAWINGS

FIG. 1 is a block diagram illustrating a method of manufacturing oilfield components according to embodiments disclosed herein.

FIG. 2 is a schematic drawing, partially in cutout view, of a flange neck reinforced for fatigue control according to embodiments disclosed herein.

### DETAILED DESCRIPTION

In one aspect, embodiments disclosed herein relate to a method of manufacturing or reinforcing oilfield components. In other aspects, embodiments disclosed herein relate to oilfield components that have been selectively reinforced to reduce or eliminate fatigue failures. In selected embodiments, a method to reinforce an oilfield component may include analyzing the oilfield component, identifying regions subject to fatigue failure in the oilfield component, and selectively reinforcing the regions subject to fatigue failure.

As used herein, “oilfield components” refer to flanges, t-bodies, stress joints, BOP bonnets and bodies, subsea well assemblies, and other components used in oil and gas drilling and production operations. Those skilled in the art will recognize that, although not specifically disclosed or described in detail, embodiments disclosed herein may apply to other oilfield components.

During transport, installation, and operation, oilfield components experience stress and strain based on fatigue loading conditions, many of which may occur on a continuous, semi-continuous, or cyclic basis. Loading conditions may include thermal loading, pressure loading, or mechanical loading. For example, thermal loading may occur when a wellbore is hot (e.g., 300° F.) and is located in 10,000 feet of water at 32° F. Pressure loading may result from internal (wellbore) pressure acting outward on the oilfield component or from hydrostatic (e.g., subsea) external pressure acting inward. Further, mechanical loading may include bonnet and flange bolt tightening preloads, axial tensile and compressive loads, and bending moments.

As such, the loading conditions may include at least one of internal pressure, external pressure, tension, compression, bending moments, and temperature extremes. The intensities of the local stress states placed on the equipment during these loading conditions may have a significant impact on the cyclic life of the equipment. Analyzing the performance of an oilfield component subject to various fatigue loading conditions may provide for enhancing the design and/or improving the performance of the oilfield components to extend the useful life of the oilfield component.

Fatigue failure of oilfield components may be analyzed by testing physical specimens or by analyzing component parts following fatigue failure during actual use. Physical testing or analyzing failed components may give some indication of the type and location of the fatigue loading conditions leading to the failure. Improving of parts in this manner may involve an iterative process.

As such, finite element analysis (“FEA”) may be a useful and powerful technique to analyze stresses and strains in structures or components too complex to analyze with analytical methods alone. In an FEA process, the structure or component may be broken down into many small pieces (i.e., a finite number of elements) of various types, sizes and shapes. The elements are assumed to have a simplified pattern of deformation (e.g., linear, quadratic, etc.) and are connected at “nodes” normally located at corners or edges of the elements. The elements are then assembled mathematically using basic rules of structural mechanics resulting in a large system of simultaneous equations (i.e., a mesh).

By solving this large simultaneous equation system with the help of a computer, the deformed shape of the structure or component under load may be obtained. Based on that, stresses and strains may be calculated. Suitable software to perform such FEA includes ABAQUS (available from ABAQUS, Inc.), MARC (available from MSC Software Corporation), and ANSYS (available from ANSYS, Inc.), among others.

One objective of FEA may be to isolate high stress or strain areas and identify the areas that are prone to reduced life from cyclic (i.e. fatigue) loading. The results of a finite element analysis, analyzing the performance of the component under various fatigue loading conditions, may be used to identify regions subject to fatigue failure in the oilfield component. Once the regions subject to fatigue are identified, these areas may be re-designed or may be marked for metallurgical processing, such as selective reinforcement, as will be described later.

In selected embodiments, possible load states or fatigue loading conditions for the component are determined and input into the FEA. As mentioned above, these may include normal operating pressure, high-pressure kicks, tension and bending, and temperature extremes, among other load states. The fatigue loading condition data should include typical or expected values as well as maximum and/or minimum values and the frequency at which these loads fluctuate to enable a complete analysis,

Furthermore, properties of the base material used to form the oilfield component may also be determined, thus establishing the maximum allowable peak stress value (SBpeak) of the base material. The material properties may either be determined through empirical testing or, in the alternative, may be provided from commercially available material properties data. For example, this value may be established based on field tests where, under NACE environments (i.e., environments established by NACE International for testing of oil and gas field equipment), the stress would just meet the life cycle requirement and would be less than the stress at which sulfide stress corrosion cracking would occur.

Further still, the tensile properties of the base materials may be determined. The tensile strength of a material is the maximum amount of stress (in tension) a material may be subjected to before failure. As stress is exerted upon a material, the material strains to accommodate the stress. Once the stress is too much for the material, it will no longer be able to strain, and the material fails. The failure point of the material is known as the ultimate tensile strength.

The loading conditions and material properties may then be used to analyze the oilfield component using FEA based methods. All permutations for design and operating loads should be considered to generate a complete analysis of the component. Proper bolt preloads and material characteristic data, de-rated based on temperature, should also be used.

Next, a model (i.e., a mesh of simultaneous equations) for the oilfield component may be generated for use in the finite element analysis. A three-dimensional model of the component may be generated with specific design features that may be selected to exhibit specific performance characteristics. Thus, generating a model may also include the steps of importing a component design to generate the model followed by improving the design as imported. The models may be generated from a design in a computer aided design (“CAD”) software package (e.g., AutoCAD available from Autodesk, Inc., and Pro/Engineer available from Parametric Technology Corporation) and imported into the FEA software package. Alternatively, the model may be generated within the FEA packages (e.g., ABAQUS, ANSYS, and PATRAN) themselves.

Next, the loading conditions may be simulated upon the component in FEA using the model. Preferably, these simulated fatigue loading conditions reflect the load states or stress that the oilfield component may expect to experience under normal use. Further, after simulating fatigue loading conditions upon the model, a stress plot from the loading conditions showing the stress and deformation occurring in the oilfield component model may be analyzed. The stress plot may determine and show the location and amount of stress occurring in the oilfield component model from the simulated loading conditions across the component.

Furthermore, the stress plot output from the FEA may be analyzed and reviewed to determine the performance characteristics of the model. If the model requires improvement, an additional model may be generated and simulated using FEA, then analyzed and reviewed to determine its performance characteristics. Otherwise, if the former model is considered acceptable and meets any and/or all specified criteria, the model may be used in the manufacture of oilfield components, as will be described below.

Thus, in selected embodiments, the objectives of the FEA analysis may include identifying, isolating, and highlighting zones subject to fatigue failure within the oilfield components. For example, the stress states which may cause early failure under the NACE environment may be identified. The results of the FEA may be used to generate stress and strain plots for identifying regions subject to fatigue failure in the component.

The identified regions may be modified in the manufacture of the oilfield component. For example, the zones may be marked out, in a spatial representation or drawing, noting the depth and lateral extents (length and width) of high stress areas subject to fatigue failure. A contour plot may be drawn, showing the length, width and depth of the local stress areas. The surface location of the fatigue zones, for example, may be transferred to appropriate manufacturer's drawings. The identified fatigue zones may then be selectively reinforced with a higher strength material bonding metallurgically with the base material.

Therefore, in some embodiments, instances of fatigue failure may be reduced or prevented by surface substitution methods, such as selective reinforcement and/or cladding. For example, if some depth of the part base metal of low-alloy steel is removed and replaced with a higher strength material and a metallurgical bond with the base metal is developed, fatigue failures may be reduced or eliminated. The higher strength alloy may be any alloy that exhibits the strength, ductility and corrosion resistance required by the design of the oilfield components or parts. Such an alloy may include other low-alloy or medium alloy steels with higher strength than the low-alloy steel base metal and would be capable of withstanding the applied stresses with a lower ratio of applied stress to yield strength. Lowering the ratio of applied stress to yield strength of the higher strength material would reduce its tendency to initiate fatigue crack initiation, fatigue crack propagation and ultimate fatigue failure.

In accordance with selected embodiments, the base material may be selectively reinforced with an inlay clad or an overlay clad, wherein the clad material may be bonded to the base material through pressure, heat, welding, brazing, roll bonding, explosive bonding, weld overlaying, wallpapering, or any combination thereof. Furthermore, the cladding may be bonded to the base material using an electric arc welding process, such as a submerged arc welding process or a tungsten inert gas welding process. Alternatively, the cladding may be bonded to the base material using an electric arc weld cladding process, a hot isostatic pressing (“HIP”) cladding process, auto-frettage cladding, laser cladding, or a combination of any of these methods. Further still, in selected embodiments, two or more clad layers may be used, including, but not limited to, a double clad (i.e., having 3 layers), or a seven-layer cladding process. Alternatively, the clad inlay may be shrunk-fit or press fit into recesses cut in the body of the oilfield component, and seam/seal welded in place.

In other embodiments, the clad inlay may be shaped according to the results of the analyzed stress plots generated using FEA. Furthermore, in selected embodiments, the clad inlay (or a clad overlay) may have a thickness or an average thickness of 0.625 inches or higher. In other embodiments, the clad inlay may have an average thickness from about 0.010 inches to about 0.625 inches, from about 0.050 to about 0.500 inches, or from about 0.125 to about 0.375 inches.

The choice of the cladding alloy may be based on its ability to resist corrosion, including stress corrosion cracking, and its ability to add mechanical strength (e.g., by a metallurgical bond to the low-alloy substrate) to the portion of the oilfield component to which it is applied and intended to protect. In one example, the strength of the cladding material may at least equal the strength of the base metal to which it is applied. That is, the weld deposited alloy (such as Alloy 625) may match the yield strength of the low-alloy steel base metal (such as low-alloy steel having a yield strength of 75,000 psi). Furthermore, it may be possible to apply a cladding of a higher strength material in a thickness that will encapsulate the localized stresses in the higher strength clad layer, resulting in an oilfield component that will meet NACE or other standards for oil and gas field components and equipment while meeting the strength and fatigue requirements of the design.

In selected embodiments, the base material may be F22 low-alloy steel, a steel having approximately 2.25 weight percent chromium and 1 weight percent molybdenum. Those skilled in the art will recognize that other corrosion resistant materials, having appropriate corrosion resistance, hardness, and tensile properties suitable for use in an oil and gas environment, may also be used. In selected embodiments, the clad overlay or clad inlay may be formed from high yield strength, corrosion resistant alloys, such as Alloy 625, or Alloy 725. Those skilled in the art will recognize that other high strength corrosion resistant materials may also be used as a cladding. Preferably, the cladding material is compatible with the base material, which will be understood by those skilled in the art. In some embodiments, the clad overlay or clad inlay may be formed with alloys with much higher yield strength than Alloy 625 or Alloy 725.

The alloys for use as a cladding may be available in the form of weld wire, powder, or strip filler metal for weld cladding and may also be available in the form of a powder intended to be used in a HIP cladding operation. These alloys may also be available in other forms that may be used in an auto-frettage cladding operation.

Once the cladding method or combination of cladding methods has been chosen, the minimum thickness and locations of the clad layer may be determined based on the results of the FEA stress analysis. The required thickness or depth of the cladding may vary depending upon the alloy used in forming the cladding, the bond formed between the clad and the base materials, as well as the dilution of the clad material resulting from the process used to bond the clad material to the base material.

Once the values and location of the areas subject to fatigue failure have been determined, the cladding alloy may be chosen. It may not be necessary to clad the entire oilfield component. Particularly, only portions of the component may need to be clad. Furthermore, it may be possible to selectively place a much lower clad thickness in lower stressed areas, thus preventing corrosion of those areas subject to contact with the well bore fluid.

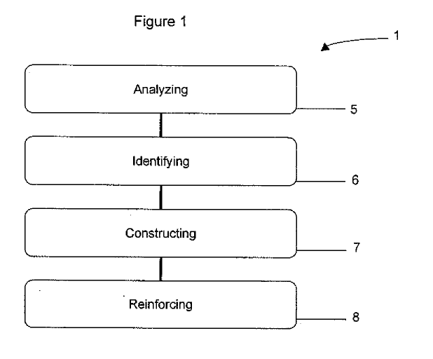

Thus, as described above, embodiments disclosed herein may provide a method of manufacturing selectively reinforced oilfield components. Referring now to FIG. 1, the method 1 may include the steps of analyzing 5, identifying 6, constructing 7, and reinforcing 8. Analyzing 5 may include generating results from a first model of an oilfield component and analyzing the results of the model under fatigue loading conditions. Identifying 6 may include identifying at least one region susceptible to failure at a selected fatigue loading condition. In some embodiments, a stress plot of the results may be used to aid in identifying regions susceptible to fatigue. Constructing 7 may include constructing the oilfield component from a base material, such as a low-alloy steel. Reinforcing 8 may include selectively reinforcing the at least one region susceptible to failure in the constructed oilfield component with a clad material. In some embodiments, the clad material may be a corrosion resistant alloy. In other embodiments, the clad material may have a higher strength than the base material.

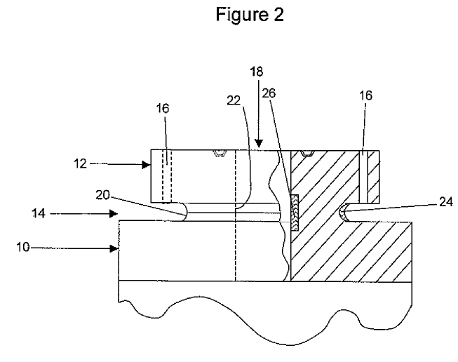

Referring now to FIG. 2, a schematic drawing of a flange neck reinforced for fatigue resistance is illustrated. A body 10 of an oilfield component is attached to an integral flange 12 by flange neck 14. Flange neck 14 may experience fatigue loading conditions due to the movement of components attached to flange 12, due to the tensioning of the bolts in bolt holes 16, internal pressure pushing outward on the vessel body 10 due to a fluid in bore 18, and other loading conditions. The outer diameter surface 20 of flange neck 14 and the inner diameter surface 22 of vessel 10 across the wall thickness from the flange neck 14 are commonly subjected to high fatigue loading conditions, and may be selectively reinforced using a clad inlays 26 and a clad overlay 24 as described above.

In an exemplary embodiment, a high-strength alloy (e.g., Alloy 625, Alloy 718, or Alloy 725) may be used for clad overlay 24 and inlay 26, while a low-alloy steel may be used for body 10. Particularly, appropriate low-alloy steels for body 10 may include, but are not limited to, 4130, 8630 Modified, and F22. As shown in FIG. 2, component body 10 may be constructed of F22 low-alloy steel having a minimum yield strength of 85,000 psi while clad overlay 24 and inlay 26 may be constructed from Alloy 625. As such, if flange neck 14 is an 8-inch integral neck, overlays 24 and inlays 26 approximately 0.5″ in thickness may be used to enhance the fatigue life of the component, wherein the choice of the cladding alloy may be made on the basis of the ratio of its yield stress to the applied stress.

Furthermore, component 10 may represent a flange of a ram-type or an annular BOP body subjected to fatigue loading conditions as deployed subsea. Blowout preventer bodies in subsea wellhead stacks may be subject to considerable cyclic bending loads resulting from tensile and bending loads which may result in a severe fatigue condition on flange necks. Selective reinforcement may additionally provide greater resistance to stress corrosion cracking to these areas that are subject to fatigue loading conditions.

In another example, drilling or production riser stress joints may be selectively reinforced to reduce or eliminate fatigue failures. This stress joint has in the past been manufactured from a high strength titanium alloy capable of withstanding much more bending deflection than a low-alloy steel. However, titanium components are very expensive to construct and are not characterized as having a fatigue strength. Whereas steel components exhibit a fatigue strength, under which a component will not fail from fatigue regardless of the number of cycles, titanium components will eventually fail regardless of the magnitude of the cyclic loading. Therefore, by selectively reinforcing a low-alloy steel, it may be possible to manufacture a stress joint capable of withstanding the bending and deflection associated with the stress joint for longer times (i.e., more cycles) using a lower cost material.

Embodiments and methods disclosed herein may advantageously provide for generating and analyzing oilfield component models with FEA using stress and/or fatigue analysis to determine the component's response under fatigue loading conditions characterized by large amounts of stress. The resulting analysis may then be used to enhance component design, improving the performance of the component under fatigue loading conditions.

Advantageously, embodiments disclosed herein may provide a method to establish an overall oilfield component design based on ASME Section-VIII Div-3 or similar HPHT equipment design guidelines. The component may satisfy NACE peak stress and life cycle requirements. Methods and embodiments disclosed herein may provide for oilfield components with an increased working lifespan. For example, the oilfield component may be modeled with simulated fatigue loading conditions of repeated compression, bending, etc., to determine design features that may extend the working lifespan of the oilfield component.

Advantageously, embodiments disclosed herein may provide a method to manufacture oilfield components that is less costly than attempting to manufacture the component from a solid, high strength corrosion resistant alloy or other metal that may meet the requirements of NACE MR0175. This is especially true in view of the fact that the mechanical strength of the body beneath the clad layer 0.250 to 0.500 inches from the well bore fluid wetted surfaces may be much lower that that required within that localized zones subject to fatigue failure. Other embodiments may provide for the enhancement of existing component designs so that sulfide stress corrosion cracking (SSCC) or corrosion related limit conditions may be met by selectively reinforcing the oilfield component with higher strength material suitable for use in an oil and gas environment.

The selection of the cladding alloy may be based on the increased mechanical strength of the clad layer and may also be based on the metallurgical bond achieved between the clad layer and the substrate. An additional attribute of the clad layer may be the corrosion resistance that the cladding alloy may contribute to the oilfield component. Another attribute of the clad layer is that any scoring or gouging of the interior surface of the component is not likely to extend below the depth of the clad layer, thus allowing the clad layer to continue to protect the low-alloy steel substrate on which it is deposited from corrosion. Particularly, the clad layer may also continue to protect the component from pitting corrosion often found in the wellbore cavities of oilfield components. Moreover, the repair of gouges in the clad layer may be easier and less costly to perform than the repair of similar damage to the low-alloy steel substrate.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A method of manufacturing an oilfield component, the method comprising:
analyzing a first model of the oilfield component;
identifying at least one region in the oilfield component susceptible to fatigue failure at a selected loading condition;
constructing the oilfield component from a base material;
selectively reinforcing with a clad material the at least one region susceptible to failure.

2. The method of claim 1, wherein the identifying comprises performing a finite element analysis.

3. The method of claim 1, wherein the identification of the at least one region susceptible to fatigue failure comprises generating a stress plot of the first model in response to the selected loading condition.

4. The method of claim 3, further comprising analyzing a second model of the oilfield component, wherein the second model is generated to minimize the at least one region susceptible to fatigue failure identified in the first model.

5. The method of claim 1, wherein the selective reinforcement comprises at least one of a clad overlay and a clad inlay.

6. The method of claim 1, wherein the clad material comprises at least one of a corrosion resistant alloy and a material having a higher strength than the base material.

7. The method of claim 1, wherein the clad material has a greater fatigue resistance than the base material.

8. The method of claim 1, wherein the oilfield component is one of a BOP body and a riser stress joint.

9. The method of claim 1, wherein the at least one region selectively reinforced comprises a flange neck.

10. A method to reinforce an oilfield component, the method comprising:
analyzing the oilfield component;
identifying at least one region susceptible to fatigue failure in the oilfield component;
selectively reinforcing with a high-strength material the at least one region susceptible to fatigue failure.

11. The method of claim 10, wherein the at least one region identified comprises a flange neck.

12. The method of claim 10, wherein the oilfield component comprises one of a riser stress joint and a BOP body.

13. The method of claim 10, wherein the identification of the at least one region susceptible to fatigue failure comprises generating a stress plot of a model of the oilfield component in response to a fatigue loading condition.

14. The method of claim 10, further comprising selecting a thickness of the selective reinforcement based upon a result of the analysis of the oilfield component.

15. The method of claim 10, wherein the selective reinforcement is performed by at least one of electric arc weld cladding, hot isostatic press cladding, and auto frettage cladding.

16. The method of claim 10, wherein the selective reinforcement comprises at least one of a clad overlay and a clad inlay.

17. The method of claim 10, wherein the selective reinforcement is shrink-fit into a recess cut in the oilfield component and welded in place.

18. The method of claim 10, wherein the selective reinforcement is press-fit into a recess cut in the oilfield component and welded in place.

19. The method of claim 10, wherein the selective reinforcement is shaped based upon a result of a finite element analysis of the oilfield component.

20. A ram blowout preventer, comprising:
a body;
a vertical bore through the body;
a horizontal bore through the body intersecting the vertical bore;
one or more ram assemblies disposed in the horizontal bore on opposite sides of the body, wherein the ram assemblies are adapted for controlled lateral movement to and from the vertical bore; and
a flange neck;
wherein at least a portion of at least one flange neck is selectively reinforced to improve fatigue resistance.

21. The ram blowout preventer of claim 20, wherein the at least a portion of the flange neck is selectively reinforced based upon a finite element analysis to identify regions susceptible to fatigue failure.
